(19) United States
(12) Patent Application Publication
(10) Pub. No.: US 2011/0010945 A1
(43) Pub. Date: Jan. 20, 2011

(54) CABLE SLITTER

(76) Inventor: DARYLE DELAFOSSE, St. George (CA)

Correspondence Address: Mark A. Koch;Professional Corporation, 583 Main Street East, Hamilton, ON, L8M 1J4, CA

(21) Appl. No.: 12/504,105

(22) Filed: Jul. 16, 2009

(51) Int. Cl. H02G 1/12; B26D 3/12; B26D 1/22

(52) U.S. Cl. 30/90.9; 83/872; 83/435; 83/436.45

(57) ABSTRACT

A cable slitter comprises a support frame and slitting wheel operatively mounted on support frame in position to slit a cable driven longitudinally along the slitting wheel. A rotatable drive wheel is operatively mounted on the support frame for rotation about a substantially horizontal drive axis, in spaced relation from the slitting wheel to together define a substantially longitudinal cable slitting path there between. A slit-adjustment means moves one of the slitting means and the rotatable drive wheel means transversely with respect to the other between a plurality of slitting positions. A drive motor selectively rotates the rotatable drive wheel, to thereby cause a cable in the substantially longitudinal cable slitting path to move forwardly along the substantially longitudinal cable slitting path and engage the slitting wheel, thus causing the cable to be slit.

### FIELD OF THE INVENTION

The present application claims the benefit of previously filed Canadian Utility Application No TBA filed Jun. 23, 2009 under the title CABLE SLITTER, by Daryle Delafosse.

The present invention relates to a cable slitters, and more particularly to portable cable slitters.

### BACKGROUND OF THE INVENTION

Electrical cables typically have one or more electrical conductors made from copper or aluminum, surrounded by plastic insulation, with each of the conductors together surrounded by a protective sheath. The pieces of electrical cable, which may be several feet long that are not used in an electrical installation, are typically sold to a scrap dealer in order to recover, or at least partially recover, some of the value of the copper or aluminum. The value of the pieces of cable is quite low if the cable is in its original sheathed form; however, if the sheath is removed from the metal wire, then the metal wire can sold at a much higher value. Accordingly, it is common to strip the cable either through use of a hand tool, which is slow, cumbersome and can be done un-safely or alternatively by means of cable slitting machines. Unfortunately, known prior art cable slitting machines are either large and relatively expensive, or small and manually powered. In either case, they do not work well Typically, they pull the cable unevenly and therefore do not maintain proper alignment of the cable with the cutting blade, thereby causing the cable and the cutting blade to become disengaged one from the other.

One such example of a electrical cable slitter can be found in U.S. Pat. No. 6,131,289, issued Oct. 17, 2000 to Tarpill, discloses a Cable Slitter for Separating Side-by-Side Cables Connected by a Web of Insulating Material. It includes a slitting blade for separating the cables and a shaving blade for removing excess web material. The shaving blade is mounted on a hinge member between the pair of guide projections. The hinge member is mounted on the tool body and swings to an open position to receive the cable to be separated, thus allowing the cable to be positioned on a second pair of guide projections on the tool body. The hinge member swings to a closed position to pierce the web material and trap the cable between the guide projections on the hinge member and the guide projections on the body. The guide projections act relative to the “valleys” defined by the web material and the outer circumferences of the cables to guide the tool as the tool is moved lengthwise along the cables. The shaving blade is positioned relative to a surface having a notch therein to remove any excess web material prior to installing the connectors on the cable.

U.S. Pat. No. 6,247,253 issued Jun. 19, 2001 to Lawler, discloses a Sheathing Slitter and Cutter Tool that includes a body that is used to retain a slitter-blade and a cutter-blade. The slitter-blade includes a first knife edge that is located on a first side of the tool body when the blade is mounted on the body and a second knife edge that is located on the other side of the tool body. The knife edges are oriented such that the first knife edge may be used for slitting a cable sheathing by pushing the tool while the first knife edge is engaging in the sheathing and the second knife edge may be used for slitting a cable sheathing when pulling the tool while the second knife edge is engaging the sheathing. The cutter-blade includes a knife edge that faces an opening in the body when the cutter-blade is mounted in the body.

It is an object of the present invention to provide a cable slitter that is inexpensive.

It is another object of the present invention to provide a cable slitter that works well.

It is a further object of the present invention to provide a cable slitter that is not manually powered.

It is a further object of the present invention to provide a cable slitter that precludes the cutting blade and cable from becoming disengaged one from the other during operation.

### SUMMARY OF THE INVENTION

In accordance with one aspect of the present invention there is disclosed a novel cable slitter comprising a support frame, and slitting means operatively mounted on the support frame in position to slit a cable driven longitudinally along the slitting means. A rotatable drive wheel means is operatively mounted on the support frame for rotation about a substantially horizontal drive axis, in space relation from the slitting means to together define a substantially longitudinal cable slitting path there between. There is a slit-adjustment means for moving the slitting means and the rotatable drive wheel means transversely with respect to the other between a plurality of slitting positions. There is also a drive means for selectably rotating the rotatable drive wheel means, to thereby cause a cable in substantially longitudinal cable slitting path to move forwardly along the substantially longitudinal cable slitting path and engage the slitting means, thus causing the cable to be slit.

In accordance with another aspect of the present invention there is disclosed a novel drive wheel assembly for use in a cable slitter. The drive wheel assembly comprises a left drive wheel having a plurality of circumferentially disposed cable engaging teeth, for engaging a cable to slit, and a right drive wheel having a plurality of circumferentially disposed cable engaging teeth, for engaging a cable to be split. Each of the left drive wheel and the right drive wheel are mountable in driveable relation on a rotatable drive shaft for rotation therewith, so as to be positioned adjacent each other such that a cable to be slit is engaged by the plurality of teeth on each of the left and right drive wheel members.

In accordance with another aspect of the present invention there is disclosed a novel drive wheel assembly for use in a cable slitter. The drive wheel assembly comprises a left drive wheel having a plurality of circumferentially disposed cable engaging teeth, for engaging a cable to slit, and a right drive wheel having a plurality of circumferentially disposed cable engaging teeth, for engaging a cable to be split. A peripheral trough is defined by the left and right drive wheels for receiving therein a cable to be slit. Each of the left drive wheel and the right drive wheel is mountable on a rotatable drive shaft in driveable relation for rotation therewith.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the cable slitter according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view from the front right of a preferred embodiment of the cable slitter according to the present, invention;

FIG. 2 is a rear perspective view from the back right of the preferred embodiment cable slitter of FIG. 1;

FIG. 3 is a right side elevational view of the preferred embodiment cable slitter of FIG. 1;

FIG. 4 is a front elevational view of the preferred embodiment cable slitter of FIG. 1;

FIG. 5 is a rear elevational view of the preferred embodiment cable slitter of FIG. 1;

FIG. 6 is an exploded front perspective view from the front right of the preferred embodiment cable slitter of FIG. 1;

FIG. 7 is a cross-sectional perspective from the front right of a portion of the preferred embodiment cable slitter of FIG. 1, taken along section line 7-7 of FIG. 4;

FIG. 8 is a sectional perspective view from the front right of the preferred embodiment cable slitter of FIG. 1, taken along section 8-8 of FIG. 3;

FIG. 9 is an sectional perspective view from the front right of the preferred embodiment cable slitter of FIG. 1, taken along section line 9-9 of FIG. 3 with right half of the support frame removed for the sake of clarity;

FIG. 10 is a right side elevational cross-sectional view of the preferred embodiment cable slitter of FIG. 1, taken along section line 10-10 of FIG. 4, showing the slitting wheel and support arm in a lower position in solid lining and in a raised position in dashed lining;

FIG. 11 is a perspective view from the front right of the preferred embodiment of the cable slitter according to the present invention, showing the cable slitter mounted on a table and an electric drive motor operatively connected thereto;

FIG. 12 is a perspective view from the front right of the preferred embodiment cable slitter of FIG. 1, showing a cable entered into the substantially longitudinal cable slitting path;

FIG. 13 is a cross-sectional side elevational view from the right of the preferred embodiment cable slitter of FIG. 1, taken along section line 13-13 of FIG. 12 with a front portion of the cable having been slit by the slitting wheel;

FIG. 14 is a front elevational view of the preferred embodiment cable slitter of FIG. 1, with a front portion of the cable having been slit by the slitting wheel;

FIG. 15 is a front elevational view of the preferred embodiment cable slitter of FIG. 1, similar to FIG. 14, but with the slitting wheels in a mating position and with spacers located outboard of each slitter wheel, and with the slitting wheel and support arm in a correspondingly lowered position, and with a smaller cable in the substantially longitudinal cable slitting path and being slit by the slitting wheel;

FIG. 16 is a perspective view from the front right of the preferred embodiment cable slitter of FIG. 1, showing the cable slitter mounted on a conventional portable power unit for threading steel pipe and operatively connected thereto so as to be driven by the pipe threader, which is itself mounted on a table;

FIG. 17A is an enlarged front elevational view of the right drive wheel of the preferred embodiment cable slitter of FIG. 1;

FIG. 17B is an enlarged side elevational view of the right drive wheel of the preferred embodiment cable slitter of FIG. 1;

FIG. 17C is a very enlarged front elevational view of a portion of the right drive wheel of FIG. 17A; and,

FIG. 18 is a section perspective view similar to FIG. 8, but with the slitting wheels in a mating position and with the spacers located outboard of each slitter wheel.

### DETAILED DESCRIPTION OF A PREFERRED EMBODIMENT

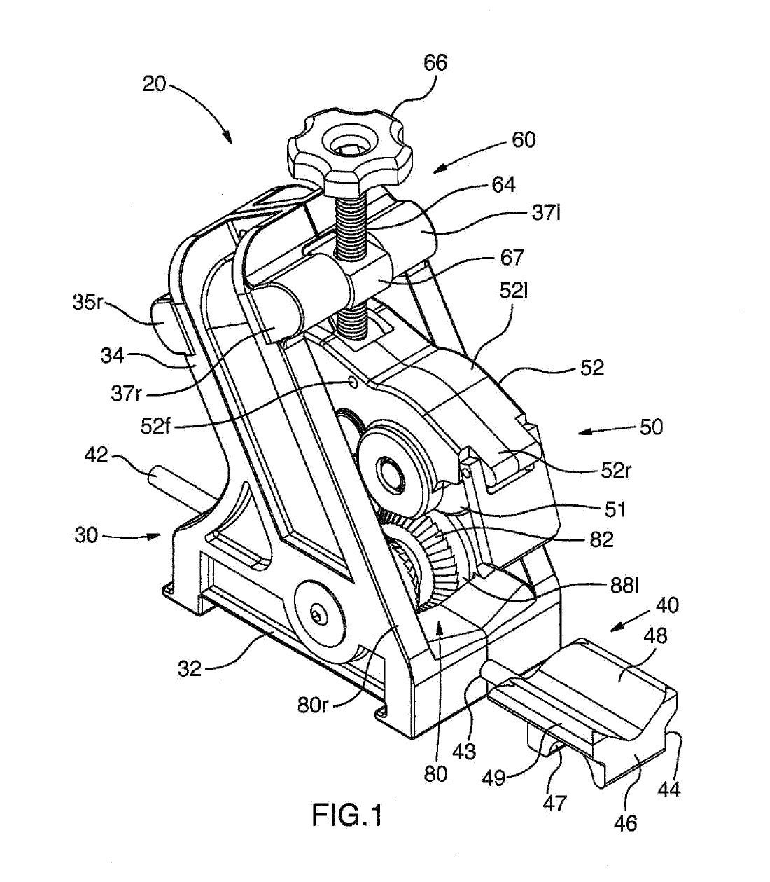

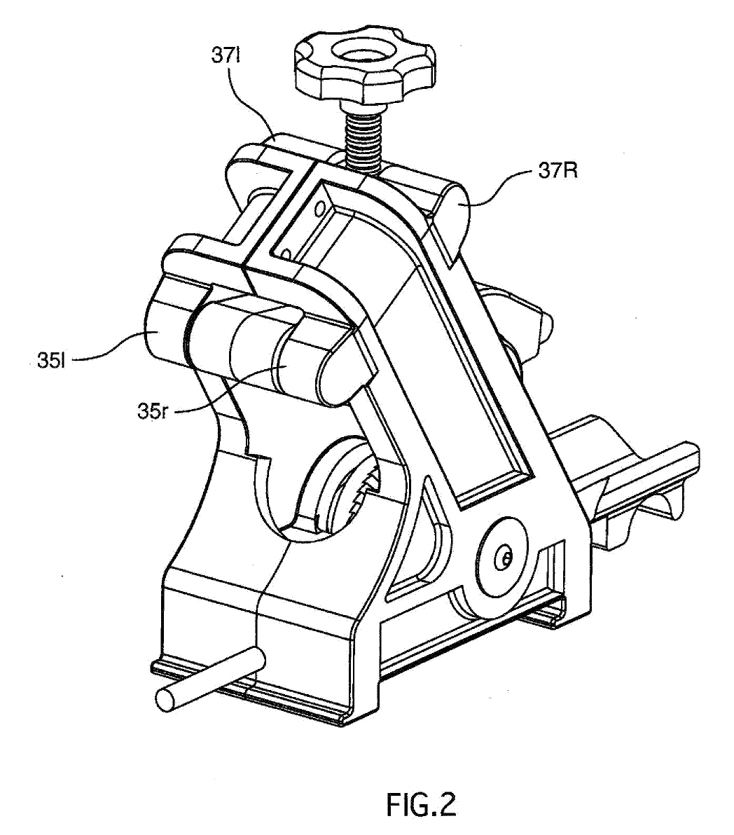

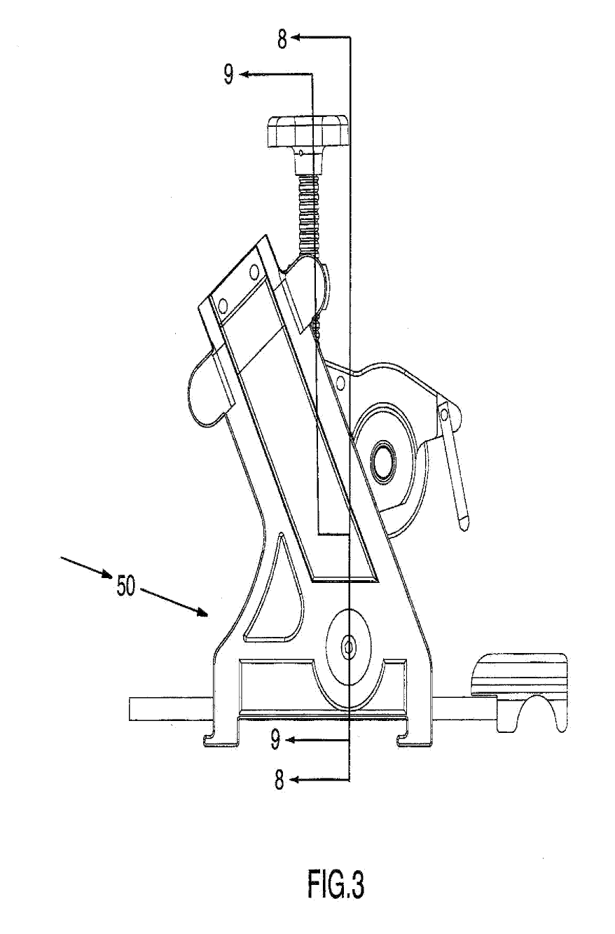

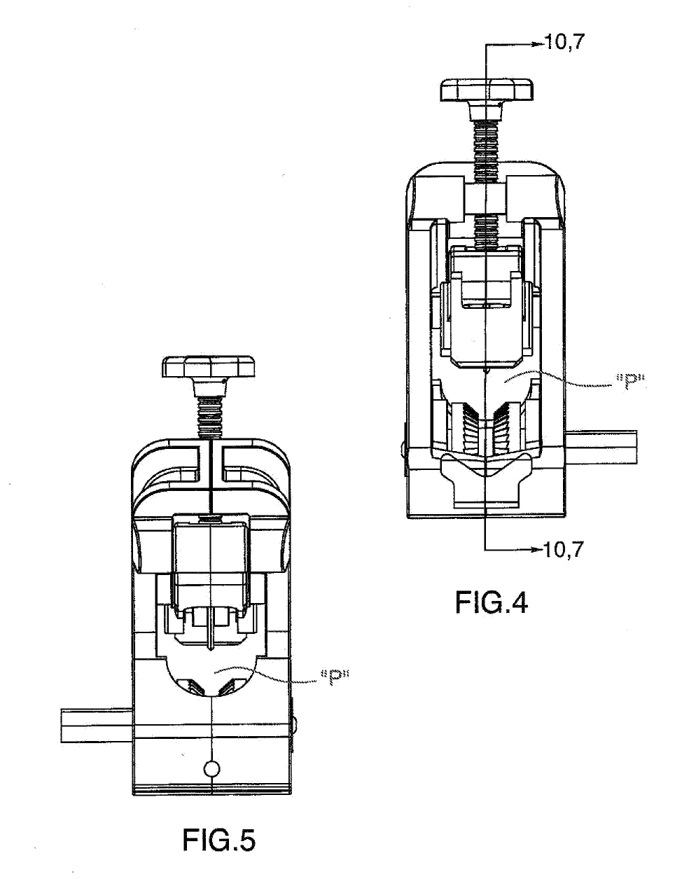

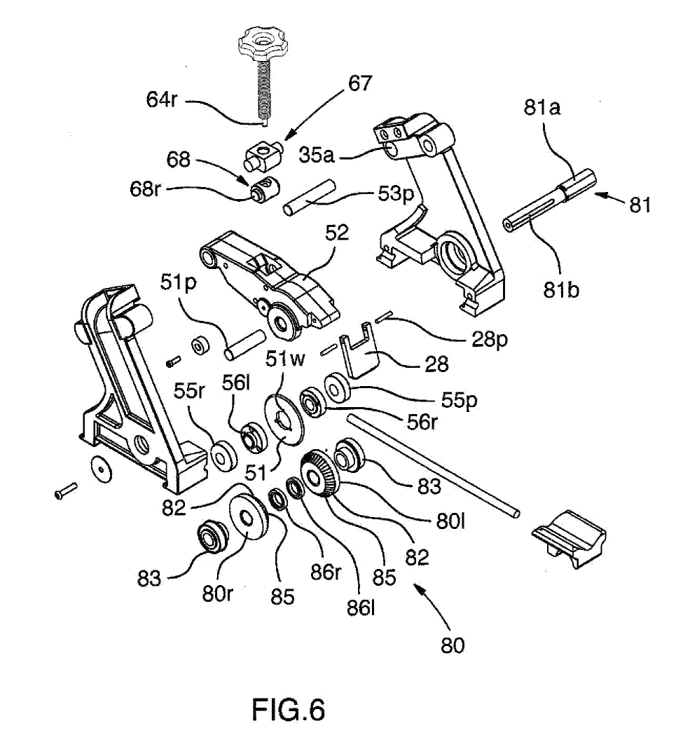

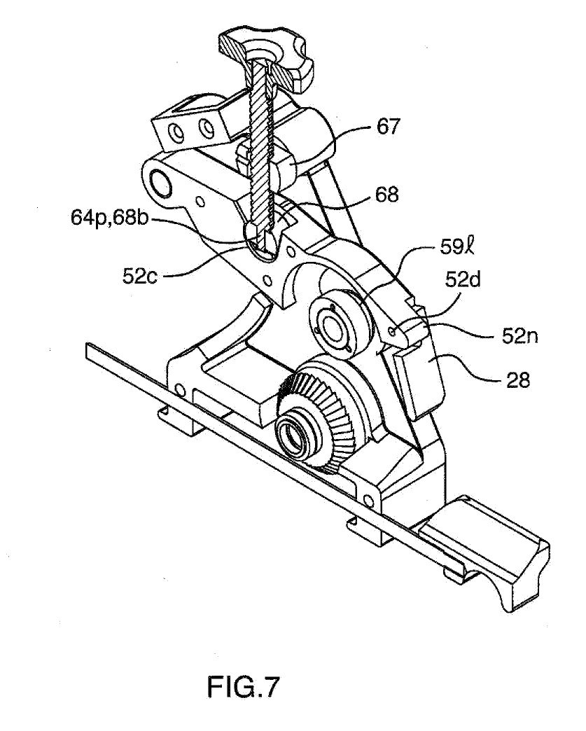

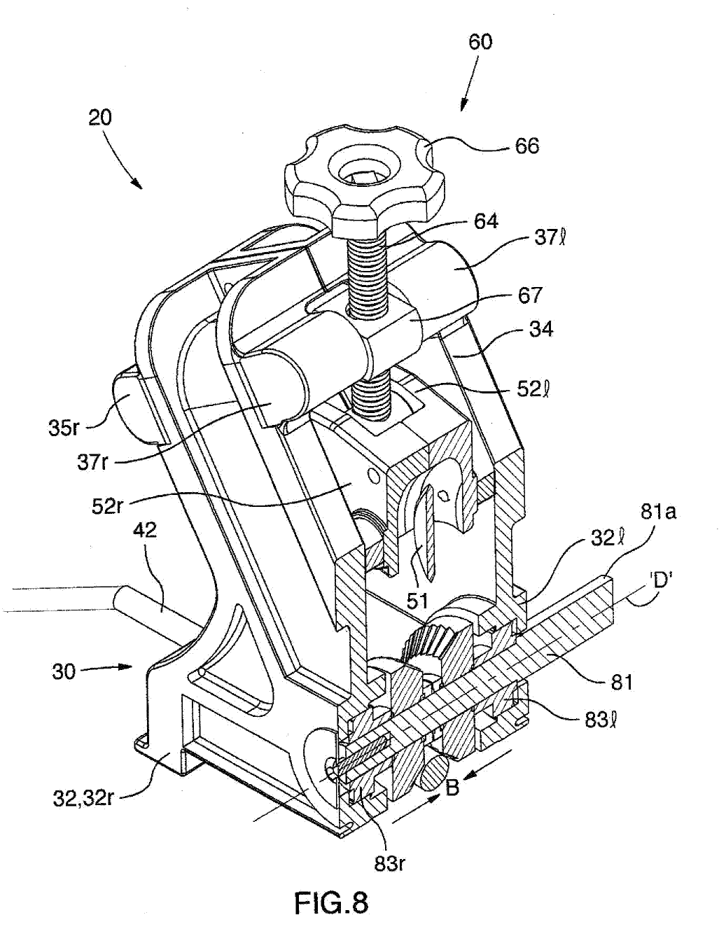

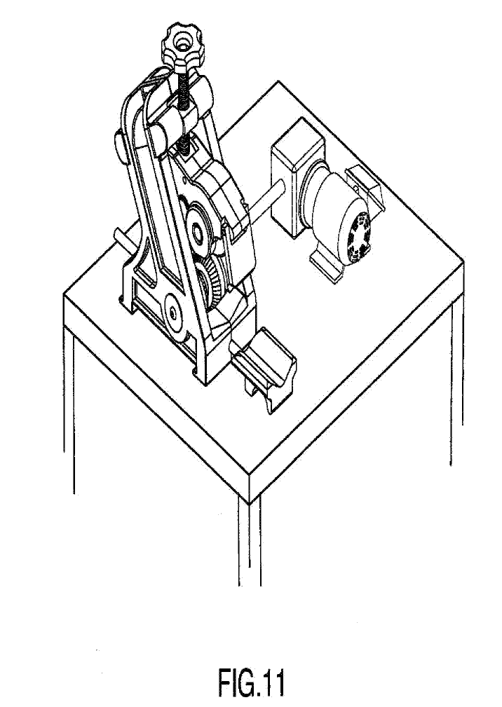

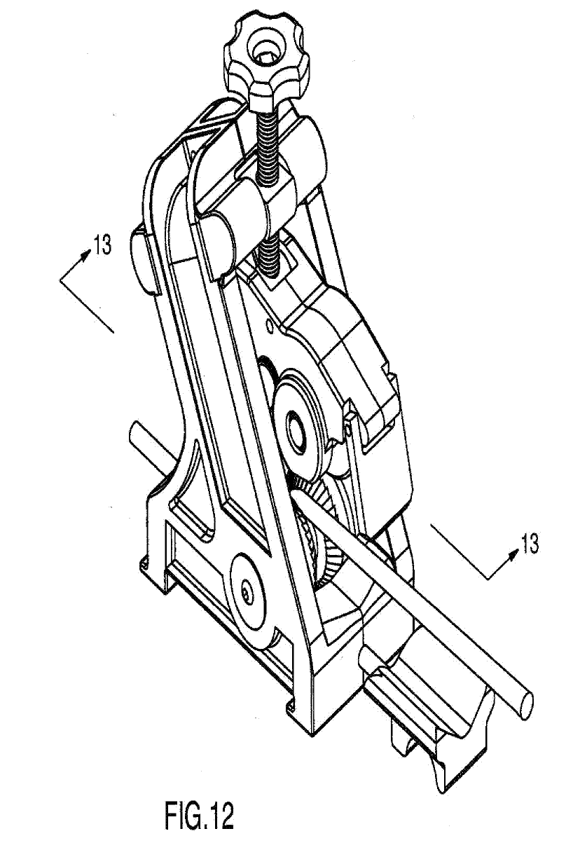

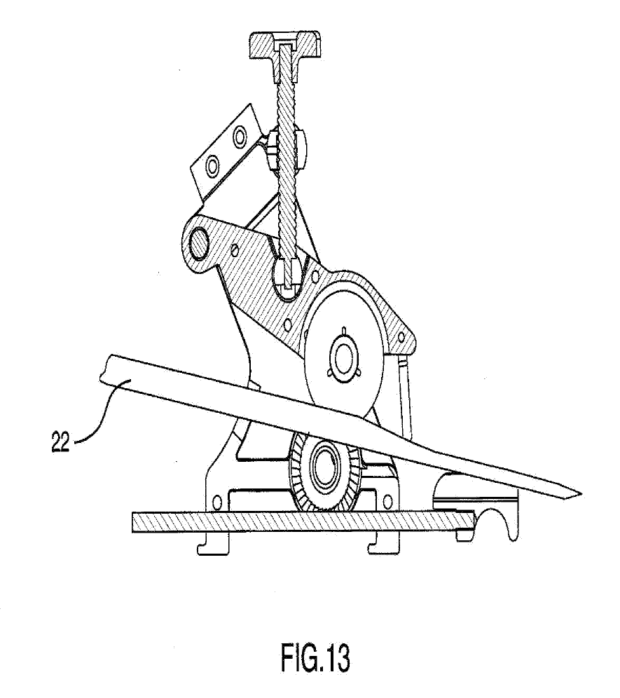

Reference will now be made to FIGS. 1 through 18, which show a preferred embodiment of the cable slitter of the present invention, as indicated by general reference numeral 20. The cable slitter 20 comprises a cable slitter 20 for slitting the outer plastic or aluminum sheath 24 or sheaths of a multi-wire cable 22, as shown in FIGS. 12 through 14, in order to permit separation of the copper or aluminum wire or wires 25, for the purpose of reclaiming the copper or aluminum.

The cable slitter 20 comprises a support frame 30 that is preferably made from metal, typically steel or aluminum, for the purpose of strength and rigidity. The support frame 30 may be secured to a stand, such as a tripod, or to a table or the like to place the cable slitter 20 at an appropriate work height. As can be readily seen in the figures, the support frame 30 comprises a lower base portion 32 and an inverted “U”-shaped cage portion 34 extending upwardly from the base portion. The lower base portion 32 of the support frame 30 comprises a left half 321 and a right half 32r secured together by threaded fasteners.

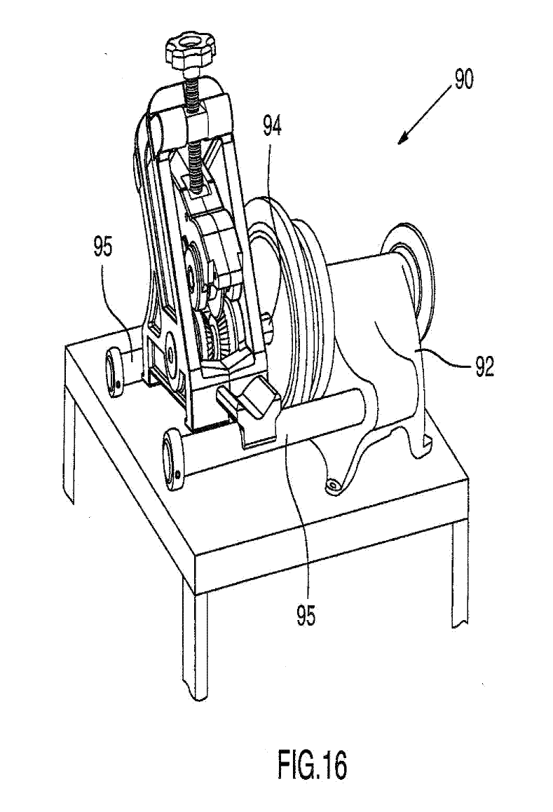

The cable slitter 20 further comprises a cable-exiting guide 40 disposed on the support frame 30 for guiding a cable 22 along the substantially longitudinal cable slitting path “P”. The cable-exiting guide 40 comprises an elongate cylindrical rod 42 extending through a co-operating aperture 43 in the lower base portion 32, as defined by the left and right halves of the support frame 30. A guide trough member 44 is secured to the front end of the elongate cylindrical rod 42. The guide trough member 44 has a central base portion 46 and left and right side flanges 48, 49 extending upwardly and outwardly from the central base portion 46. An inverted semi-circular trough 47 is disposed in the bottom of the central base portion 46 for permitting the cable slitter 20 to be mounted on a pipe threader 90, as can be seen in FIG. 16. The pipe threader 90 is driven by an electric motor (not shown).

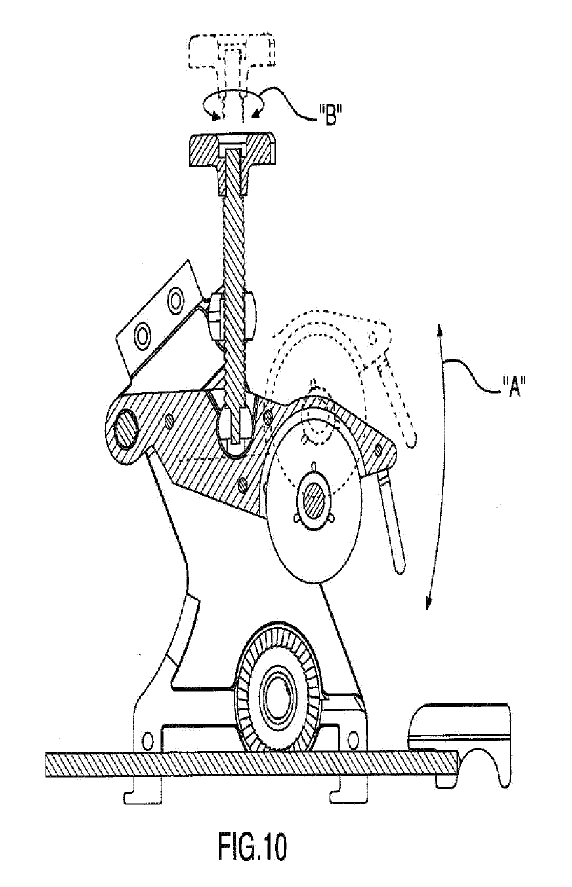

As can be best seen in FIGS. 10 through 16, the cable-exiting guide 40 is oriented to guide a cable 22 substantially horizontally. With the cable-exiting guide 40 oriented in this manner, the weight of the cable 22 being slit is borne by the cable-exiting guide 40, and the cable 22 can be readily slid forwardly during slitting.

A slitting means 50 is operatively mounted on the support frame 30 in position to slit a cable 22 driven longitudinally along the slitting means 50. The slitting means 50 is preferably operatively mounted on the support frame 30 by means of a vertically pivoting mounting arm 52 that is mounted in hinged relation on the support frame 30 for generally vertical pivoting movement of the mounting arm 52 between a plurality of vertical positions, as will be discussed in greater detail subsequently.

The vertically pivoting mounting arm 52 has a left half 521 and a right half 52r joined together by threaded fasteners 52f. A pivot pin 53p extends horizontally outwardly from a rear hub of the mounting arm 52 to fit in freely pivoting relation in co-operating bore holes 35a in the rearwardly protruding left and right seat portions 35l,35r located on the back of the inverted “U”-shaped cage portion 34.

The slitting means 50 preferably comprises a slitting wheel 51 mounted in freely rotatable relation on the mounting arm 52 by means of a large pin member 51p extending through left and right bearings 55l,55r that are each received in co-operating left and right annular seats 59l,59r in the mounting arm 52. The bearings 55l, 55r permit solid rotational mounting of the slitting wheel 51, thus keeping the slitting wheel 51 properly aligned and also precluding the slitting wheel 51 from wearing at its central mounting aperture, which would otherwise occur if the slitting wheel 51 was directly mounted on a spindle or the like due to frictional rotation on the spindle, The slitting wheel 51 is made from a suitable high carbon heat treated steel material and has a sharp peripheral cutting edge that readily slits the sheath or sheaths of a cable 22.

There is also a slit-adjustment means 60 for moving one of the slitting means 50 and the rotatable drive wheel assembly 80 transversely with respect to the other between a plurality of slitting positions. The slit-adjustment means 60 comprises a threaded rod 64 connected adjacent one end to the mounting arm 52 and threadibly engaged in a co-operating threaded aperture 30a in the support frame 30, such that rotation of the threaded rod 64 causes the mounting arm 52 and the slitting wheel 51 to move between the plurality of slitting positions. The mounting arm 52 includes a plurality of indicia 52i thereon for indicating the slitting position of the, mounting arm 52 with respect to the support frame 30.

More specifically, the mounting arm 52 is manually movable between a plurality of substantially vertical slitting positions by means of a manually rotatable threaded rod 64 having a manually graspable handle 66 secured to the top end of the manually rotatable threaded rod 64. The handle 66 has a plurality of indicia thereon for indicating the relative position of the mounting arm 52 with respect to, the support frame 30.

The manually rotatable threaded rod 64 is threadibly engaged in a co-operating connector body 67 that is itself pivotally mounted in the forwardly protruding left and right seat portions 37l,37r located on the front of the inverted “U”-shaped cage portion 34, immediately forwardly of the rearwardly protruding left and right seat portions 35l,35r. The manually rotatable threaded rod 64 terminates at its bottom end in a vertically oriented pin 64p portion that is securely engaged in frictional relation in a co-operating bore hole 68b in a cylindrically shaped mounting member 68 that is retained within a co-operating cylindrical chamber 52c to maximize contact surface area in the mounting arm 52. The cylindrically shaped mounting member 68 also has left and right pivot pins 68l,68r that are axially aligned one with another and extend horizontally outwardly from the cylindrically shaped mounting member 68 to fit in freely pivoting relation in co-operating bore holes 52b in the mounting arm 52.

The slitting wheel 51 is supported axially by annular seated left and right hubs 56l, 56r, respectively. The left and right hubs 56l, 56r are secured together through the slitting wheel 51 by threaded fasteners (not shown). The left and right hubs 56l,56r are secured to the drive shaft 81 by threaded fasteners seated into the drive shaft 81 to transfer the rotation forces to the bearings 55l,55r.

The mounting arm 52 also includes a left guide bushing 59l and a right guide bushing 59r disposed on the left and right sides of the mounting arm 52, respectively. The left and right guide bushings 59l,59r contact the inner surfaces of the support frame 30 in sliding relation to keep the mounting arm 52 laterally centered within the support frame 30. Accordingly, in use, the slitting means 50 remains properly centered on the cable 22 being slit.

There is also a protective operator guard 28 attached in freely pivoting relation to the front end nose portion 52n of the mounting arm 52. The protective operator guard 28 is retained in place by means of a pair of pin members 28p securely retained in frictional engagement within a co-operating bore holes 52d the nose portion 52n of the mounting arm 52 and bore holes 28b in the protective operator guard 28.

As can be readily seen in FIG. 10, the mounting arm 52 is manually movable between a plurality of vertical positions, as indicated by arrow “A”, by rotation of a manually rotatable handle 66, as indicated by arrow “B”. In FIG. 10, the mounting arm 52 and slitting wheel 51 are shown in dashed lining in a maximum raised adjustment position, and are shown in solid lining in an intermediate adjustment position, which is the same position as is shown in FIGS. 1-5, 7-9, and 11-14. The intermediate adjustment position is used in the illustrations for the sake of clarity, and is used for slitting larger diameter cables. FIG. 10 shows the mounting arm 52 and slitting wheel 51 in solid lining in a more lowered adjustment position, suitable for cutting smaller size cable.

A rotatable drive wheel means 80 is operatively mounted on the support frame 30 for rotation about a substantially horizontal drive axis “D”, in spaced relation from the slitting means 50 to together define a substantially longitudinal cable slitting path “P” there between. The substantially horizontal drive axis “D” is oriented transversely to the substantially longitudinal cable slitting path

The rotatable drive wheel means 80 comprises at least one drive wheel. In the preferred embodiment, the at least one drive wheel comprises a left drive wheel 80l and a right drive wheel 80r that are operatively mounted on a drive shaft 81 by means of left and right drive bearings 83 that are received within co-operating annular left and right recesses, respectively. The drive shaft 81 has a hexagonally shaped end portion 81a for engaging a drive means 90. A keyway 81b extends most of the length of the drive shaft 81 for receiving a co-operating key 80k on each of the left drive wheel 80l and the right drive wheel 80r, to permit the drive shaft 81 to positively rotate the left drive wheel 80l and the right, drive wheel 80r.

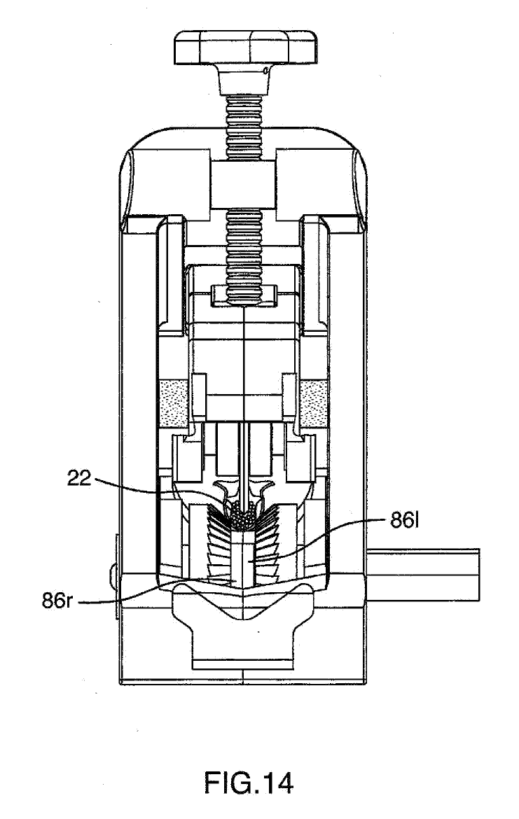

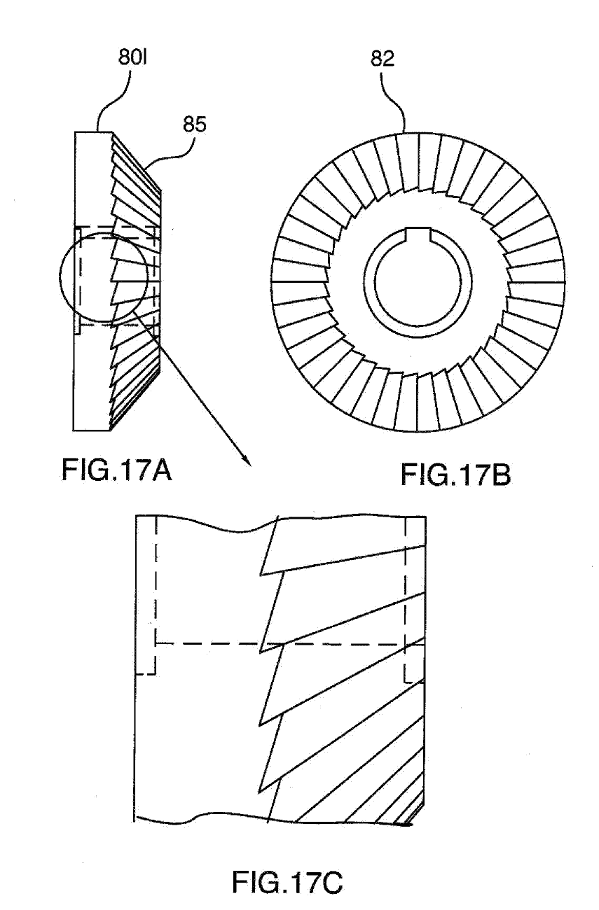

The left drive wheel 80l and the right drive wheel 80r each have a plurality of circumferentially disposed cable engaging teeth 82, for engaging a cable 22 to be slit. More specifically, the left drive wheel 80l and a right drive wheel 80r each have a peripheral beveled portion 85, with the plurality of cable engaging teeth 82 are disposed on the peripheral beveled portion 85. As can be best seen, in FIG. 14, the plurality of cable engaging teeth 82 on the left drive wheel 80l are circumferentially offset with respect to the plurality of cable engaging teeth 82 on the right drive wheel 80r. Further, the teeth 82 are “back” cut with a sharper angle, as can be best seen in FIGS. 17A-17C in order to provide a better grip on the cable 22. The plurality of cable engaging teeth 82 on the left drive wheel 82l are circumferentially offset with respect to the plurality of cable engaging teeth on the right drive wheel 80r (half way out of phase) to maximize contact area with the cable 22. This off-set phasing of cable engaging teeth 82 allows for more consistent depth of sheath cutting by the cutting wheel 51, due to a more even gripping surface gained by means of the more constant shape of the lower trough.

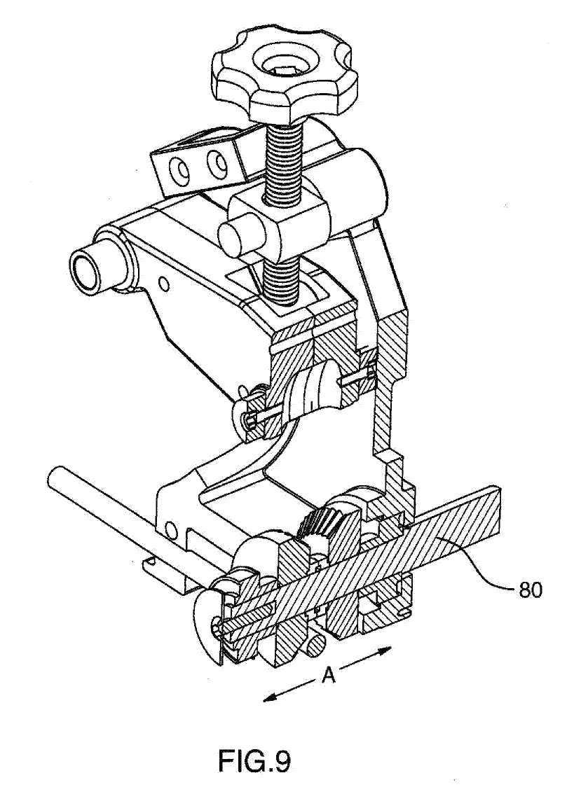

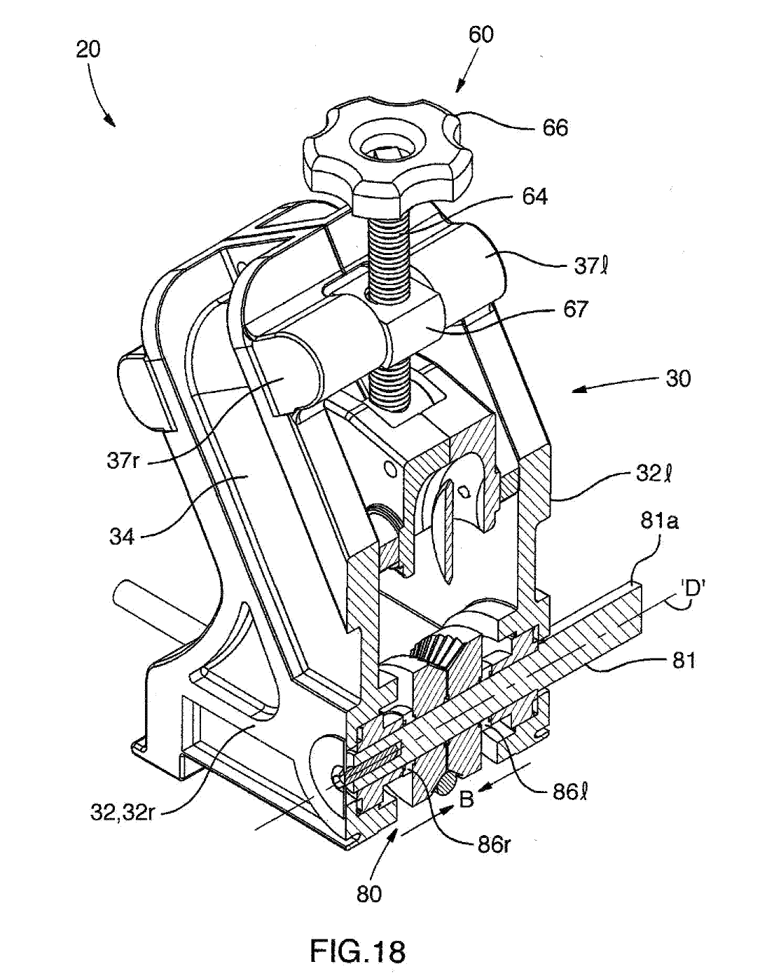

There is also a pair of spacer members in the form of spacer bushings 86 (a left spacer bushing 86l and a right spacer bushing 86r) that can fit along the drive shaft 81 between the left drive wheel 80l and the right drive wheel 80r, as shown in FIG. 9. This configuration is used for slitting larger diameter cables. Alternatively, as shown in FIG. 18, the spacer bushings 86 can fit on the drive shaft 81 such that the left spacer bushing 86l is disposed between the left drive bearing 83l and the left drive wheel 80l, and the right spacer bushing 86r is disposed between the right drive bearing 83r and the right drive wheel 80r. This configuration is used for slitting small diameter cables.

There is also drive means 90 for selectively rotating the rotatable drive wheel means, to thereby cause a cable 22 in the substantially longitudinal cable slitting path “P” to move forwardly along the substantially longitudinal cable slitting path “P” and engage the slitting means 50, thus causing the cable 22 to be slit. In the preferred embodiment, as illustrated, the means for selectively rotating the rotatable drive wheel means comprises a pipe threader 92 having an electrically powered motor (not shown), engaging the drive shaft 81, and a pair of cylindrical mounting arms 95, as can be best seen in FIG. 16.

In another aspect, the present invention also encompasses a drive wheel assembly 80 for use in a cable slitter 20. The drive wheel assembly 80 comprises the left drive wheel 80l and the right drive wheel 80r. The left drive wheel 80l has a plurality of circumferentially disposed cable engaging teeth 82, for engaging a cable 22 to be slit, and the right drive wheel 80r has a plurality of circumferentially disposed cable engaging teeth 82, for engaging a cable 22 to be slit, as described above. Each of the left drive wheel 80l and the right drive wheel 80r are mountable in driveable relation on the rotatable drive shaft 81 for rotation therewith, so as to be positioned adjacent each other such that a cable 22 to be slit is engaged by the plurality of teeth on each of the left and right drive wheels 80l,80r.

In yet another aspect, the present invention further encompasses a drive wheel assembly 80 for use in a cable slitter 20, wherein the drive wheel comprises the left drive wheel 80l and the right drive wheel 80r. The left drive wheel 80l has a plurality of circumferentially disposed cable engaging teeth 82, for engaging a cable 22 to be slit, and the right drive wheel 80r having a plurality of circumferentially disposed cable engaging teeth 82, for engaging a cable 22 to be slit, as discussed above. A peripheral trough is defined by the left and right drive wheel 80r, 80l portions for receiving therein a cable 22 to be slit. Each of the left drive wheel 80l and the right drive wheel 80r are mountable on a rotatable drive shaft 81 in driveable relation for rotation therewith. Further, in the drive wheel assembly 80, the left drive wheel 80l and the right drive wheel 80r each have a peripheral beveled portion 85, and wherein the plurality of cable engaging teeth 82 are disposed on the peripheral beveled portion 85.

In use, as can be seen in FIGS. 12 through 15, the cable 22 to be slit is fed into the cable slitter 20 such that the lead end of the cable 22 engages the drive wheel assembly 80, specifically the left drive wheel 80l and the right drive wheel 80r, which are already rotating. The left drive wheel 80l and the right drive wheel 80r draw the cable 22 forwardly along the slitting wheel 51. The slitting wheel 51 has been vertically adjusted, as indicated by arrow “A” in FIG. 14, to be in an appropriate slitting position for slitting the sheath of the cable 22 by turning the manually rotatable handle 66, as indicated by arrow “B” in FIG. 14. In other words, the area between the cable 22 and the slitting wheel 51 is slightly less than, the diameter of the cable 22. The forward motion of the cable 22 along the slitting wheel 51 causes the slitting wheel 51 to rotate, thus readily slitting the sheath of the cable 22, as is best seen in FIGS. 12 through 14. Once the entire cable 22 has passed through the cable slitter 20, the sheath 24 may be easily removed from the internal wires 25.

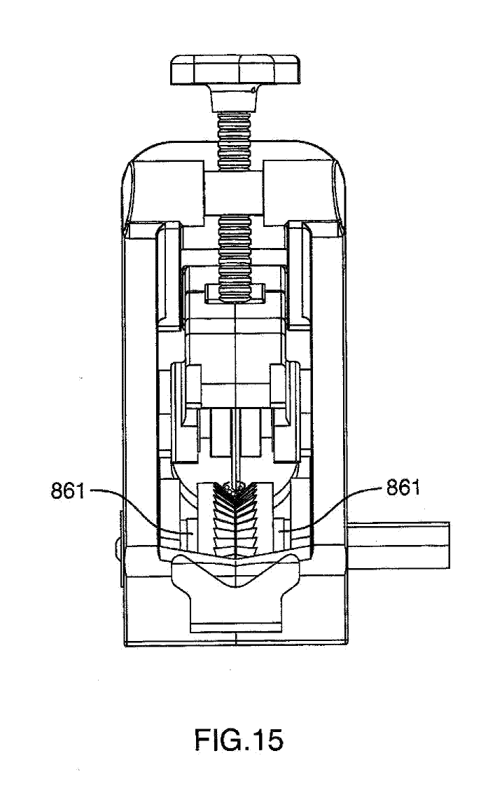

In FIG. 15, the vertical position of the slitting wheel 51 has been lowered via rotation of the manually rotatable handle 66 to an appropriate slitting position for slitting the smaller diameter sheath of the cable 22′ as shown.

As can be understood from the above description and from the accompanying drawings, the present invention provides cable slitter that is inexpensive, that works well, that is not manually powered, and that precludes the cutting blade and cable from becoming disengaged one from the other during operation, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the cable slitter of the present invention without departing from the spirit and scope of the accompanying claims.

I claim:

1. A cable slitter comprising:
a support frame;
slitting means operatively mounted on said support frame in position to slit a cable driven longitudinally along said slitting means;
rotatable drive wheel means operatively mounted on said support frame for rotation about a substantially horizontal drive axis, in spaced relation from said slitting means to together define a substantially longitudinal cable slitting path there between;
slit-adjustment means for moving one of said slitting means and said rotatable drive wheel means transversely with, respect to the other between a plurality of slitting positions;
drive means for selectively rotating said rotatable drive wheel means, to thereby cause a cable in said substantially longitudinal cable slitting path to move forwardly along said substantially longitudinal cable slitting path and engage said slitting means, thus causing said cable to be slit.

2. The cable slitter of claim 1, wherein said rotatable drive wheel means comprises at least one drive wheel.

3. The cable slitter of claim 2, wherein said at least one drive wheel comprises a left drive wheel and a right drive wheel.

4. The cable slitter of claim 3, wherein said left drive wheel and a right drive wheel are operatively mounted on a drive shaft.

5. The cable slitter of claim 4, wherein said left drive wheel and said right drive wheel each have a plurality of circumferentially disposed cable engaging teeth, for engaging a cable to be slit.

6. The cable slitter of claim 5, wherein said left drive wheel and a right drive wheel each have a peripheral beveled portion, and wherein said plurality of cable engaging teeth are disposed on said peripheral beveled portion.

7. The cable slitter of claim 6, wherein said plurality of cable engaging teeth on said left drive wheel are circumferentially offset with respect to said plurality of cable engaging teeth on said right drive wheel.

8. The cable slitter of claim 1, wherein said slitting means is operatively mounted on said support frame by means of a mounting arm.

9. The cable slitter of claim 8, wherein said mounting arm is mounted in hinged relation on said support frame.

10. The cable slitter of claim 9, wherein said slitting means comprises a slitting wheel mounted in freely rotatable relation on said mounting arm.

11. The cable slitter of claim 10, wherein said slit-adjustment means comprises a threaded rod connected adjacent one end to said mounting arm and threadibly engaged in a co-operating threaded aperture in said support frame, such that rotation of said threaded rod causes said mounting arm and said slitting wheel to move between said plurality of slitting positions.

12. The cable slitter of claim 1, wherein said support frame comprises a base portion and a cage portion extending upwardly from said base portion.

13. The cable slitter of claim 1, further comprising a cable-receiving guide disposed on said support frame for guiding a cable along said substantially longitudinal cable slitting path.

14. The cable slitter of claim 13, wherein said cable-receiving guide is oriented to guide a cable substantially horizontally.

15. The cable slitter of claim 1, wherein said substantially horizontal drive axis is oriented substantially transversely to said substantially longitudinal cable slitting path.

16. A cable slitter of claim 1, wherein said mounting arm includes a plurality, of indicia thereon for indicating the slitting position of said mounting arm with respect to said support frame.

17. A cable slitter of claim 16, wherein said handle includes a plurality of indicia thereon.

18. A drive wheel assembly for use in a cable slitter, said drive wheel assembly comprising:
a left drive wheel having a plurality of circumferentially disposed cable engaging teeth, for engaging a cable to be slit;
a right drive wheel having a plurality of circumferentially disposed cable engaging teeth, for engaging a cable to be slit;
wherein each of said left drive wheel and said right drive wheel are mountable in driveable relation on a rotatable drive shaft for rotation therewith, so as to be positioned adjacent each other such that a cable to be slit is engaged by said plurality of teeth on each of said left and right drive wheel members.

19. The drive wheel assembly of claim 18, further comprising at least one spacer member mountable in driveable relation on said rotatable drive shaft for rotation therewith.

20. A drive wheel assembly for use in a cable slitter, said drive wheel comprising:
a left drive wheel having a plurality of circumferentially disposed cable engaging teeth, for engaging a cable to be slit;
a right drive wheel having a plurality of circumferentially disposed cable engaging teeth, for engaging a cable to be slit;
a peripheral trough defined by said left and right drive wheels for receiving therein a cable to be slit;
wherein each of said left drive wheel and said right drive wheel is mountable on a rotatable drive shaft in driveable relation for rotation therewith,

21. The drive wheel assembly of claim 20, further comprising at least one spacer member mountable in driveable relation on said rotatable drive shaft for rotation therewith.

22. The drive wheel assembly of claim 20, wherein said left drive wheel and aright drive wheel each have a peripheral beveled portion, and wherein said plurality of cable engaging teeth are disposed on said peripheral beveled portion.
